(19) United States
(12) Patent Application Publication
(10) Pub. No.: US 2019/0002247 A1
(43) Pub. Date: Jan. 3, 2019

(54) SHACKLE

(71) Applicant: Choong Ho KIM, Bucheon-si, Gyeonggi-do (KR)

(72) Inventor: Choong Ho KIM, Bucheon-si, Gyeonggi-do (KR)

(21) Appl. No.: 16/072,553

(22) PCT Filed: Jan. 28, 2016
(86) PCT No.: PCT/KR2016/000928

§ 371 Date: Jul. 25, 2018

(30) Foreign Application Priority Data
Jan. 27, 2016 (KR) 10-2016-0009765

(51) Int. Cl. B66C 1/66

(52) U.S. Cl. CPC B66C 1/66; F16G 15/06

(57) ABSTRACT

Provided is a shackle, and the shackle comprises: a shackle body having holes at opposite ends formed by opening one side thereof and defining a pulling ring while an opposite side thereof is closed, and in which an auxiliary ring is additionally formed on the pulling ring; and a shackle pin that is sequentially screw-coupled to the holes formed on the one side of the shackle body while passing through the holes.

### BACKGROUND OF THE INVENTION

### 1. Field of the Invention

The present invention relates to a shackle, and more particularly to a shackle that is connected to an object-to-be-pulled of a heavy weight to smoothly pull the object, for example, in a construction field of a building or a ship manufacturing field.

### 2. Description of the Related Art

In construction processes of large-scale buildings according to the trend of the construction industry, construction of steel frames that form the bases has been regarded as the most important process. The construction of steel frames is an essential construction in an architecture process of large-scale buildings and is a process that constitutes the frame of the building, and the basic operation of the steel frame construction is to pull various steel frame structures with a tower crane installed in the field and to climb the steel frame structures while assembling the steel frame structures by an operator.

In this way, objects-to-be-pulled, such as various steel frame structures, gang forms, and ship parts, which are difficult to be moved and pulled by man power are pulled through cranes, and hooks are provided for the cranes and shackles are provided for articles so that the hooks are connected to the shacklers to pull the objects.

The technologies related to shackles are disclosed in Korean Patent Application Publication No. 10-2012-0131882.

Hereinafter, a shackle of Korean Patent Application Publication No. 10-2012-0131882, which may be easily coupled and disassembled, will be described briefly as a conventional technology.

FIG. 1 is a perspective view of a shackle of Korean Patent Application Publication No. 10-2012-0131882 (hereinafter, referred to as ‘the conventional technology’), which may be easily coupled and disassembled.

As illustrated in FIG. 1, the shackler 10 of the conventional technology, which may be easily coupled and disassembled, includes: a shackle body 100, side surfaces of opposite ends of which are spaced apart from each other by a specific interval while facing each other, a shackle pin 200 that passes through-holes 120 formed on the side surfaces of the opposite ends of the shackle body 100 to be coupled to the shackle body 100; and a safety pin 300 that passes a insertion hole 244 formed at one end of the shackle pin 200 to be coupled to the shackle pin 200, and the safety pin 300 is vertically coupled to the shackle pin 200 on the outside of the shackle body 100.

However, according to the conventional technology, the shackle of the conventional technology, which may be easily coupled and disassembled, the shackle body 100 may be damaged or deformed as a load is concentrated in the shackle body 100 in a process of connecting the hook of a crane and an object-to-be-pulled of a heavy weight with the shackle.

### PRIOR TECHNICAL DOCUMENTS

### Patent Documents

(Patent document 0001) Korean Patent Application Publication No. 10-2012-0131882

### SUMMARY OF THE INVENTION

The present invention has been made in an effort to solve the above-mentioned problems, and provides a shackle that may prevent opposite ends of a pulling ring from being deformed inwards while reinforcing strength by additionally forming an auxiliary pulling ring in a shackle body separately from the pulling ring, may minimize shaking of the shackle by connecting a rope to the pulling ring and the auxiliary pulling ring in a state in which the rope contacts a plurality of points of the pulling ring and the auxiliary pulling ring, may prevent a shackle pin from being released, through an elastic force or a bolt, and may improve tensile strength according to reinforcement of the structure by expanding one of the opposite ends of the shackle body, into which a tip end of the shackle pin is inserted first.

In accordance with an aspect of the present invention, there is provided a shackle comprising: a shackle body having holes at opposite ends formed by opening one side thereof and defining a pulling ring while an opposite side thereof is closed, and in which an auxiliary ring is additionally formed on the pulling ring; and a shackle pin that is sequentially screw-coupled to the holes formed on the one side of the shackle body while passing through the holes.

A cross-sectional area of one of the opposite ends of the shackle body may be larger than that of the other of the opposite ends of the shackle body.

One of the opposite ends of the shackle body, into which a tip end of the shackle pin is inserted first, may be expanded.

The auxiliary pulling ring may be detachably mounted on the pulling ring.

The shackle may further comprise: an elastic body inserted into an outer peripheral surface of the shackle pin to prevent loosening of the shackle pin by generating an elastic force in a direction that is opposite to an insertion direction of the shackle pin in the shackle pin when the shackle pin is coupled to the holes of the shackle body.

The shackle may further comprise: an anti-release member formed on a flange of the shackle pin to fix the shackle pin such that the shackle pin is located in a groove formed on an outer wall of one end of the shackle body.

The shackle may further comprise: an auxiliary anti-release member formed on a front side of the anti-release member and supported by an elastic member while being located in the groove formed on the outer wall of the one end of the shackle body.

When a rope is caught by the pulling ring and the auxiliary pulling ring, opposite ends of the rope wound on a lower end of the pulling ring may contact the auxiliary pulling ring in parallel to the auxiliary pulling ring or the opposite ends of the rope wound on the lower end of the pulling ring may contact the auxiliary pulling ring after crossing each other between the pulling ring and the auxiliary pulling ring.

The present invention may prevent opposite ends of a pulling ring from being deformed inwards while reinforcing strength by additionally forming an auxiliary pulling ring in a shackle body separately from the pulling ring, may minimize shaking of the shackle by connecting a rope to the pulling ring and the auxiliary pulling ring in a state in which the rope contacts a plurality of points of the pulling ring and the auxiliary pulling ring, may prevent a shackle pin from being released, through an elastic force or a bolt, and may improve tensile strength according to reinforcement of the structure by expanding one of the opposite ends of the shackle body, into which a tip end of the shackle pin is inserted first.

### BRIEF DESCRIPTION OF THE DRAWINGS

FIG. 1 is a perspective view of a shackle that may be easily coupled and disassembled according to a conventional technology;

FIG. 2 is an exploded perspective view illustrating a shackle according to a first embodiment of the present invention;

FIG. 3 is a front view illustrating a shackle according to a first embodiment of the present invention;

FIG. 4 is a perspective view illustrating a state in which a rope is caught by a pulling ring in the shackle according to the first embodiment of the present invention;

FIG. 5 is a perspective view illustrating a state in which the rope is caught by the pulling ring and an auxiliary pulling ring in the shackle according to the first embodiment of the present invention;

FIGS. 6 and 7 are front views illustrating states before and after deformation of an elastic body provided in a shackle according to a second embodiment of the present invention;

FIGS. 8 and 9 are an exploded perspective view and an enlarged view illustrating a state in which an anti-release member is provided in a shackle according to a third embodiment of the present invention; and

FIG. 10 is a partially enlarged sectional view illustrating a state in which an auxiliary anti-release member is added to the shackle according to the third embodiment of the present invention.

### DETAILED DESCRIPTION OF THE INVENTION

Hereinafter, exemplary embodiments of the present invention will be described in detail with reference to the accompanying drawings so that those skilled in the art to which the present invention pertains may easily carry out the invention. However, the present invention may be implemented in various different forms, and is not limited to the embodiments. The same reference numerals are given to the similar parts throughout the specification.

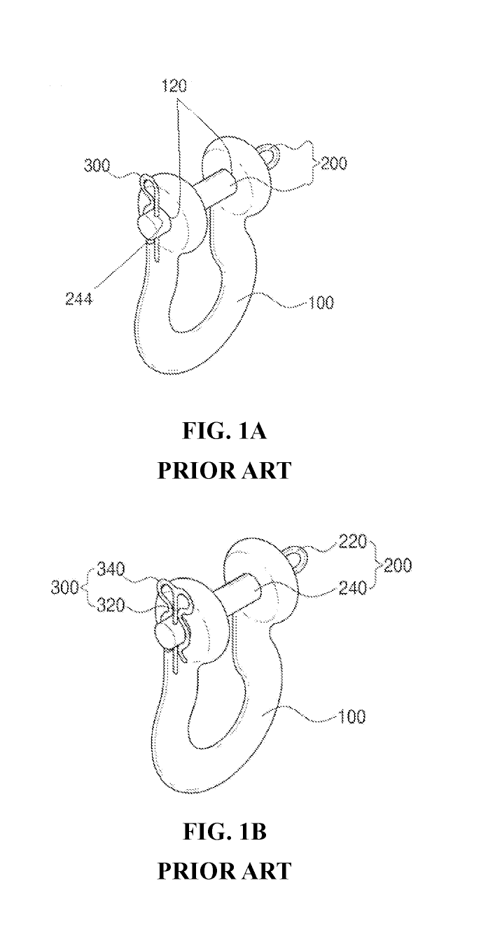

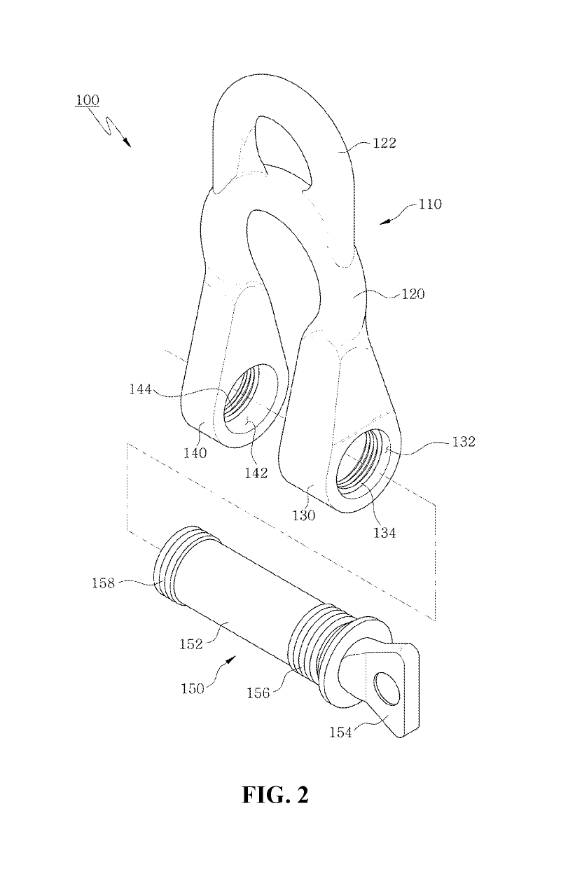

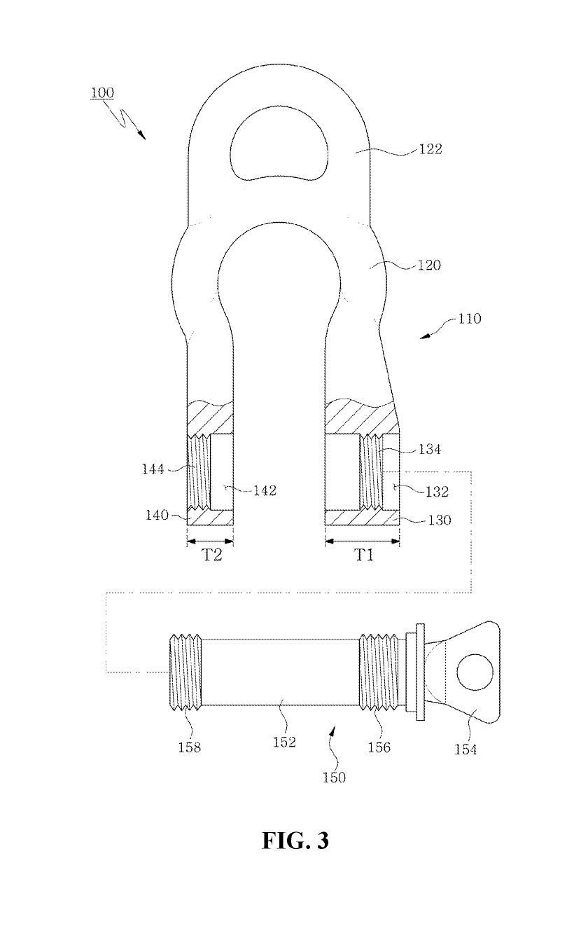

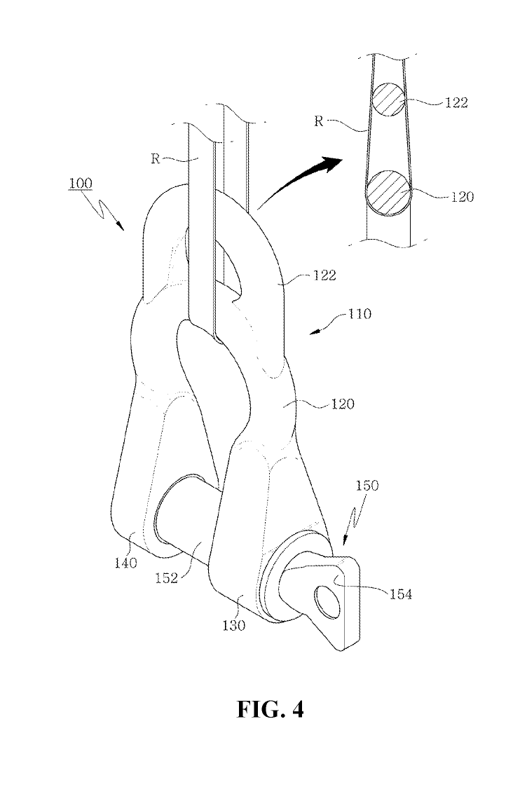

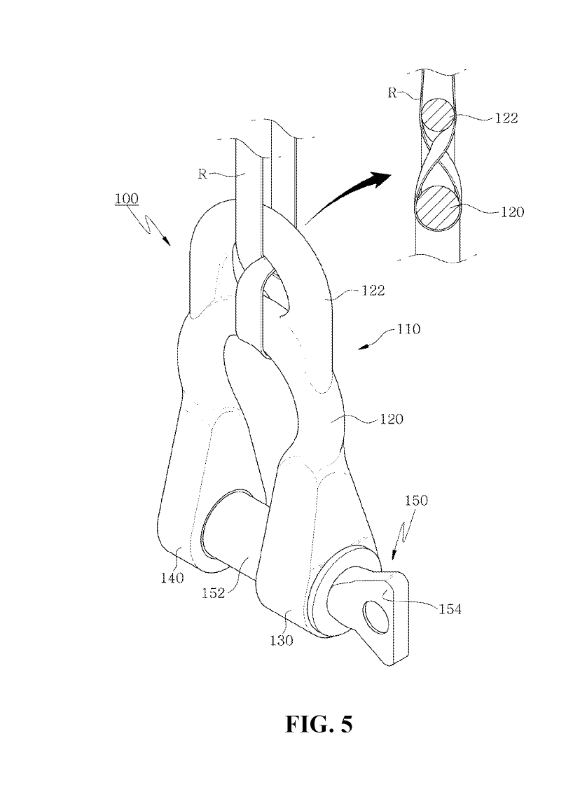

In the following description that will be made with reference to the accompanying drawings, FIG. 1 is a perspective view of a shackle that may be easily coupled and disassembled according to a conventional technology, FIG. 2 is an exploded perspective view illustrating a shackle according to a first embodiment of the present invention, FIG. 3 is a front view illustrating a shackle according to a first embodiment of the present invention, FIG. 4 is a perspective view illustrating a state in which a rope is caught by a pulling ring in the shackle according to the first embodiment of the present invention, and FIG. 5 is a perspective view illustrating a state in which the rope is caught by the pulling ring and an auxiliary pulling ring in the shackle according to the first embodiment of the present invention.

According to the drawings, the shackle 100 according to the first embodiment of the present invention, the shackle 100 includes a shackle body 110 and a shackle pin 150, and functions to connecting a hook of a crane and an object-to-be-pulled.

The shackle body 110 is formed through casting, and holes 132 and 142 pass through the same horizontal plane of opposite ends 130 and 140 formed by opening a lower end of the shackle body 110, to which the object is connected, such that a shackle pin 150, which will be described below, may be coupled to the opposite ends of the shackle body 110, a pulling ring 120 is formed by closing an upper end of the shackle body 110, to which a hook of the crane is connected, and the shackle body 110 includes an auxiliary pulling ring 122 additionally formed in the pulling ring 120.

The auxiliary pulling ring 122 is additionally formed on an upper surface of the pulling ring 120 to have an arc shape having a radius that is smaller than that of the arc of the pulling ring 120 so as to disperse a load concentrated in the pulling ring 120 while reinforcing strength.

Meanwhile, in an example of the pulling ring 120, a rope R is supported at multiple points of the pulling ring 120 and the auxiliary pulling ring 122 to prevent shaking of the shackle 100 because an inner surface of the rope R, opposite ends of which are parallel to each other, contacts opposite apex portions of the pulling ring 120 and opposite apex portions of the auxiliary pulling ring 122 when the rope R is caught and pulled. (See FIG. 4)

Further, when a rope R is dually caught by the pulling ring 120 and the auxiliary pulling ring 122 in a twisted state in which the rope R has a 8 shape so that the object is pulled as an example, inner surfaces of the rope R contact opposite apex portions of the pulling ring 120 and opposite apex portions of the auxiliary pulling ring 122, and accordingly, the rope R is supported at a plurality of points of the pulling ring 120 and the auxiliary pulling ring 122 to prevent shaking of the shackle 100. (See FIG. 5)

In particular, the auxiliary pulling ring 122 and the pulling ring 120 may be selectively used according to the weights of objects by pulling an object of a light weight with the auxiliary pulling ring 122 and pulling an object of a heavy weight with the pulling ring 120.

Then, the lower end of the shackle 100 is opened such that a connecting ring or a rope connected to the object may enter the interior of the shackle body 110 between the opposite ends 130 and 140 of the shackle 100.

Further, a screw groove 134 is formed on an inner peripheral surface of the hole 132 formed at one end 130 of the shackle body 110 such that a screw thread 156 formed at a rear end of the shackle pin 150 is screw-coupled to the screw groove 134, and a screw groove 144 is formed on an inner peripheral surface of the hole 142 formed in an opposite end 140 of the shackle body 110 such that a screw thread 158 formed at a tip end of the shackle pin 150 is screw-coupled to the screw groove 144.

Further, the cross-sectional area of the one end 130 of the shackle body 110, through which the tip end of the shackle pin 150 is inserted first becomes larger as it goes downwards to be larger than that of the cross-sectional area of the opposite end 140 of the shackle body 110 when viewed from the front side and a lateral side. That is, the thickness T1 of the one end 130 of the shackle body 110 is larger than the thickness T2 of the opposite end 140 of the shackle body 110 when the shackle body 110 is viewed from the front side.

A rear end of the shackle pin 150 is located at the one end 130 of the shackle body 110, and in this case, because a load is concentrated in the rear end of the shackle pin 150 due to the weight of a knob 154 or the like, the thickness of the one end of the shackle body 110 is made lager to solve the problem by reinforcing the shackle body 110.

The shackle pin 150 has screw threads 156 and 158 through machining while the shackle pin 150 is cast, and includes a body 152, a knob 154, and screw threads 156 and 158 as a configuration of fastening the pulling ring of the object that is coupled to the holes 132 and 142 formed at the opposite ends 130 and 140 of the shackle body 110 to be pulled or a wire connected to the object.

The body 152 is formed to have an outer diameter that is smaller than the outer diameters of the front and rear screw threads 156 and 158 through machining.

The knob 154 is formed to be exposed to the outside of the one end 130 of the shackle body 110 while extending to be adjacent to the rear thread 158, and helps the operator grip the shackle pin 150 when the shackle pin 150 is coupled to the screw grooves 134 and 144 formed in the holes 132 and 142 of the opposite ends 130 and 140 of the shackle body 110.

One screw thread 156 is formed on the rear side of the body 152 that is close to the knob 154 to be screw-coupled to the screw groove 134 formed in the hole 132 of the one end 130 of the shackle body 110, and an opposite screw thread 156 is formed on the front side of the body 152 to be screw-coupled to the screw groove 144 formed in the hole 142 of the opposite end 140 of the shackle body 110.

Then, although it has been exemplified that the screw threads 156 and 158 have the same outer diameter, the one screw thread 156 is formed to have an outer diameter that is smaller than that of the opposite screw thread 158 so that the opposite screw thread 158 passes through the screw groove 134 formed in the hole 132 of the on end 130 of the shackle body 110 without being coupled to the screw groove 134 when the shackle pin 150 is coupled to the holes 132 and 142 formed at the opposite ends 130 and 140 of the shackle body 110, making it possible to decrease time for the coupling.

Therefore, according to the shackle 100 of the first embodiment of the present invention, the opposite ends of the pulling ring 120 may be prevented from being deformed inwards while strength is reinforced by additionally formed the auxiliary pulling ring 122 on the upper surface of the pulling ring 120 formed in the shackle body 110, and the forward/rearward shaking of the shackle 100 may be minimized by connecting the rope R to a plurality of points of the pulling ring 120 and the auxiliary pulling ring 122 while the rope R contacts the pulling ring 120 and the auxiliary pulling ring 122.

Further, the pulling ring 120 or the auxiliary pulling ring 122 may be selectively used according to the weight of the object-to-be-pulled. As an example, an object of a heavy weight may be pulled by the pulling ring 120 and an object of a light weight may be pulled by the auxiliary pulling ring 122, a load concentrated in the pulling ring may be dispersed while strength is reinforced by the auxiliary pulling ring 122.

Further, when the shackle pin 150 is coupled to the holes 132 and 142 formed at the opposite ends 130 and 140 of the shackle body 110, concentration of a load by the weight of the knob 154 or the like may be prevented by making the thickness of the one end 130 of the shackle body 110, which is close to the knob 154 of the shackle pin 150 and on which the weight is concentrated, larger to reinforce the shackle body 110.

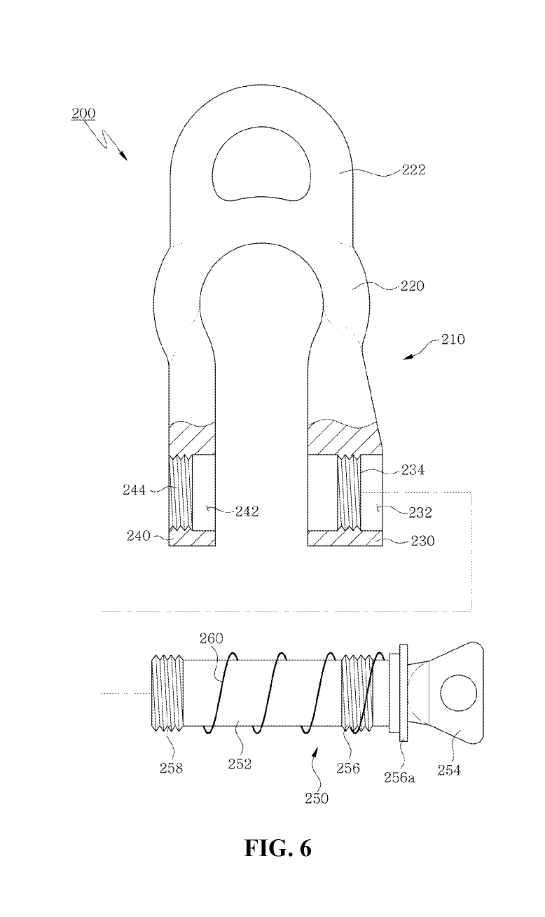

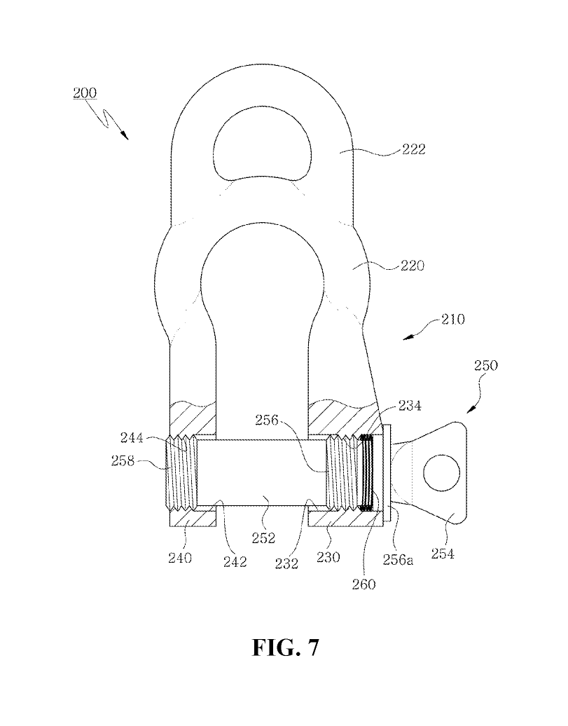

FIGS. 6 and 7 are front views illustrating states before and after deformation of an elastic body provided in a shackle according to a second embodiment of the present invention. In the drawings, the shackle 200 according to the second embodiment of the present invention includes a shackle body 210, a shackle pin 250, and an elastic body 260, and the shackle body 210 and the shackle pin 250 have the same structures as those of the previous embodiment and a detailed description thereof will be omitted.

A tip end of the elastic body 260 is compressed while the tip end of the elastic body 260 is supported by a hole 232 formed at one end 130 of the shackle body 210 and a rear end of the elastic body 260 is supported by an inner surface of a flange 256a of the shackle pin 250 when the elastic body 260 is coupled to the holes 232 and 242 formed at the opposite ends 130 and 140 of the shackle body 210 in a state in which the elastic body 260 is inserted into an outer peripheral surface of the shackle pin 250 so that the shackle pin 250 may be prevented from being loosening from the holes 232 and 242.

That is, the elastic body 260 prevents the shackle pin 250 from being loosening by generating an elastic force in the shackle pin 250 in a direction that is opposite to an insertion direction of the shackle pin 250 when screw threads 256 and 258 of the shackle pin 250 are coupled to screw grooves 234 and 244 in the holes 232 and 242 formed at the opposite ends 130 and 140 of the shackle body 210.

Then, the elastic body 260 prevents loosening of the shackle pin 250 by pressing a left side surface of the screw threads 256 and 258 of the shackle pin 250 to a right side surface of the screw grooves 234 and 244 in the holes 232 and 242 formed at the opposite ends 230 and 240 of the shackle body 210 and pressing the attached surfaces with an elastic force.

Here, reference numeral 252 denotes a body, reference numeral 254 denotes a knob, and reference numerals 256 and 258 denote screw threads.

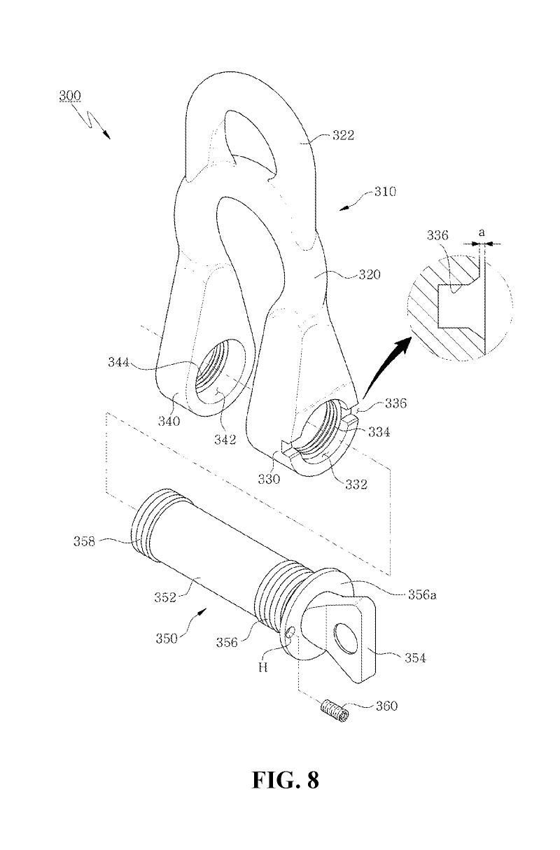

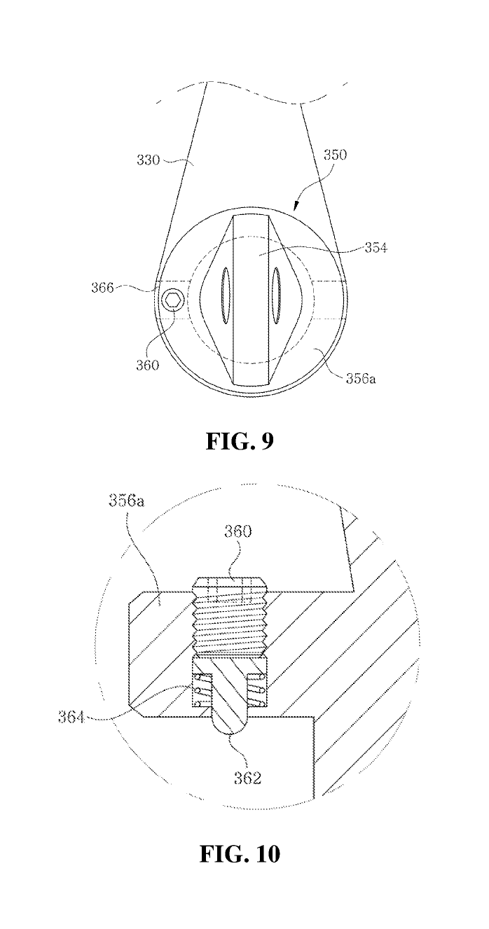

FIGS. 8 and 9 are an exploded perspective view and an enlarged view illustrating a state in which an anti-release member is provided in a shackle according to a third embodiment of the present invention. FIG. 10 is a partially enlarged sectional view illustrating a state in which an auxiliary anti-release member is added to the shackle according to the third embodiment of the present invention.

According to the drawings, the shackle 300 according to the third embodiment of the present invention includes a shackle body 310, a shackle pin 350, and an anti-release member 360, and is characterized in that the shackle pin 350 is prevented from being loosened from the shackle body 310 through the anti-release member 360.

To achieve this, loosening of the shackle pin 350 is prevented by forming a groove 336 on an outer wall of one end 330 of the shackle body 310, forming a screw hole H on a flange 356a of the shackle pin 350 corresponding to the groove 336, and coupling the anti-release member 360 to the screw hole H such that the tip end of the anti-release member 360 that is coupled first may be located in the groove 336.

Then, a headless bolt that has no bolt head or the like is applied as the anti-release member 360.

Meanwhile, the groove 336 has a height (a) by which a clockwise reference tip end of the groove 336 is lower than the rear end of the groove 336 and the corners of the tip end and the rear end of the groove 336 are chamfered such that the tip end of the anti-release member 360 may easily pass through the groove 336 or may be easily loosened before the preventing member 360 is coupled in a process of coupling a screw groove 356 is coupled to a screw groove 334 of the hole 332 formed on the one end 330 of the shackle body 310 while the shackle pin 350 is rotated clockwise.

Further, it has been exemplified that the groove 336 formed on the outer wall of the one end 330 of the shackle body 310 is formed on the opposite sides of the one end 330 of the shackle body 310 with respect the hole, the groove 336 may be formed only on one side of the one end 330 of the shackle body 310, and it is formed, considering that screw coupling ending points coincide with each other when the shackle pin 350 is coupled to the shackle body 310.

Here, although it has been exemplified that the anti-release member 360 is located in the interior of the groove 336 on the outer wall of the one end 330 of the shackle body 310 to prevent loosening of the shackle pin 350, loosening of the shackle pin 350 may be prevented in a state in which an auxiliary anti-release member 362 located on the front side of the anti-release member 360 is located in the interior of the groove 336 on the outer wall of the one end 330 of the shackle body 310.

That is, the auxiliary anti-release member 362 is a cylindrical operation pin, an upper end of which has a disk shape to be elevated along a screw hole H of the flange 356a and in which a semispherical shape is formed on the bottom surface of the disk shape.

Further, if the anti-release member 360 is loosened while the elastic member 364 is interposed in the bottom of the disk of the auxiliary anti-release member 362 and the bottom surface of the screw hole H of the flange 356a, the auxiliary anti-release member 362 is raised by an elastic force of the elastic member 364.

Here, reference numeral 340 denotes an opposite end, reference numeral 342 denotes a hole, reference numerals 334 and 344 denote screw grooves, reference numeral 352 denotes a body, reference numeral 354 denotes a knob, and reference numerals 356 and 358 denote screw threads.

Although the present invention has been described with reference to the limited embodiments and the drawings, the present invention is not limited to the embodiments, but various corrections and modifications may be made from the description by those skilled in the art to which the present invention pertains.

Therefore, the scope of the present invention is not limited to the described embodiments, and has to be determined by equivalents to the claims as well as the claims.

1. A shackle comprising:
a pulling ring in which holes pass through opposite ends thereof, which are formed by opening one side thereof, an opposite side of which is closed, and which has a round arc shape that is convex outwards;
a shackle body including an auxiliary pulling ring having a round arc shape that extends from two points of the upper convex portion of the pulling ring and having the convex portion of the pulling ring in the interior thereof; and
a shackle pin that sequentially passes through the holes formed at the opposite ends of the pulling ring to be screw-coupled to the pulling ring,
wherein a groove is formed on an outer wall of one end of the pulling ring,
wherein a flange having a hole at a location corresponding to the groove of the pulling ring is further provided at one end of the shackle pin,
wherein the shackle further comprises an anti-release member coupled to the groove of the pulling ring and the hole of the flange of the shackle pin to prevent rotation of the shackle pin, and
wherein the shackle further comprises an auxiliary anti-release member inserted into the groove of the pulling ring by the anti-release member, and an elastic member configured to separate the auxiliary anti-release member from the groove of the pulling ring when the anti-release member is extracted outwards.

2. The shackle of claim 1, wherein a cross-sectional area of one of the opposite ends of the shackle body is larger than that of the other of the opposite ends of the shackle body.

3. The shackle of claim 2, wherein one of the opposite ends of the shackle body, into which a tip end of the shackle pin is inserted first, is expanded.

4. The shackle of claim 1, further comprising:
an elastic body inserted into an outer peripheral surface of the shackle pin to prevent loosening of the shackle pin by generating an elastic force in a direction that is opposite to an insertion direction of the shackle pin in the shackle pin when the shackle pin is coupled to the holes of the shackle body.

5. The shackle of claim 1, further comprising:
an anti-release member formed on a flange of the shackle pin to fix the shackle pin such that the shackle pin is located in a groove formed on an outer wall of one end of the shackle body.

6. The shackle of claim 5, further comprising:
an auxiliary anti-release member formed on a front side of the anti-release member and supported by an elastic member while being located in the groove formed on the outer wall of the one end of the shackle body.

7. The shackle of claim 1, wherein when a rope is caught by the pulling ring and the auxiliary pulling ring, opposite ends of the rope wound on a lower end of the pulling ring contact the auxiliary pulling ring in parallel to the auxiliary pulling ring or the opposite ends of the rope wound on the lower end of the pulling ring contact the auxiliary pulling ring after crossing each other between the pulling ring and the auxiliary pulling ring.
